(19) United States
(12) Patent Application Publication
(10) Pub. No.: US 2006/0136296 A1
(43) Pub. Date: Jun. 22, 2006

(54) System and method for providing direct marketing opportunities to lottery ticket retailers

(76) Inventor: Andrew R. Amada, Phoenix, AZ (US)

Correspondence Address: TIFFANY & BOSCO P.A., THIRD FLOOR CAMELBACK ESPLANADE II, 2525 EAST CAMELBACK ROAD, PHOENIX, AZ, 85016-4237, US

(21) Appl. No.: 11/286,018

(22) Filed: Nov. 22, 2005

Related U.S. Application Data
(60) Provisional application No. 60/630,256, filed on Nov. 22, 2004.

(51) Int. Cl. G07G 1/14

(52) U.S. Cl. 705/14

(57) ABSTRACT

A system for providing direct marketing opportunities to lottery ticket retailers includes a host computer system programmed to maintain a website including separate webpages for lottery ticket retailers. The computer system stores address information for the lottery ticket retailers, receives a lottery website visitor's geographic location information and determines one or more local lottery ticket retailers located within a selected distance of the visitor's geographic location. In response to the lottery website visitor's selection of one of the local lottery ticket retailers, the system serves the webpage of the selected lottery ticket retailer for the visitor to view. The webpage of the selected lottery retailer includes promotions for a non-lottery product offered by the selected lottery ticket retailer. The lottery ticket retailers have access to webpage templates for creating their webpages.

### RELATED APPLICATION

This application is based on and claims the benefit of U.S. Provisional Patent Application No. 66/630,256 filed on Nov. 22, 2004, the disclosure of which is incorporated herein in its entirety by this reference.

### COPYRIGHT NOTIFICATION

Portions of this patent application include materials that are subject to copyright protection. The copyright owner has no objection to the facsimile reproduction by anyone of the patent document itself, or of the patent application as it appears in the files of the United States Patent and Trademark Office, but otherwise reserves all copyright rights whatsoever in such included copyrighted materials.

### BACKGROUND

This invention relates to the lottery industry. More specifically, it relates to a system and method for lottery ticket retailers to advertise their place of business and their non-lottery products via official state or jurisdictional lottery websites and/or associated websites to individually identified local lottery players and website visitors, thereby building a stronger and more profitable relationship between the lottery, the lottery ticket retailers and the lottery players.

Since the mid-1990's, competition for players' gaming dollars has increased significantly. Lotteries are competing with brick and mortar casinos as well as thousands of online casinos and poker rooms. The lotteries are looking for methods of retaining their market share of gaming dollars and increasing that share, where possible. They have always been searching for new and better ways to strengthen their relationship with the lottery retailer network, which for all intents and purposes has been their only vehicle for selling tickets. They know that a content retail force is a key ingredient to healthy lottery sales figures. Over the past few years, lotteries are also starting to develop player clubs through the Internet to build a closer relationship with their players and to keep them informed of winners and new product launches. And, like other businesses who have used the Internet, lotteries are looking to the Internet as a possible vehicle towards selling more of their products by selling directly to the public. Selling on the Internet, however, poses a problem for lotteries. They don't want to alienate the retailer network, who would not only lose lottery sales and commissions, but who would lose sales of their own products due to less walk-in traffic. Lotteries are continually coming up with new incentives to get their retailers to sell more tickets. So while the lotteries would like to use the Internet to sell directly to the public, they also know it would alienate and be very unpopular with their retailers, who would see it as at least a partial diversion of their heretofore exclusive revenue stream. The retail outlets want all lottery sales to go through their stores, not only for the commissions they earn on ticket sales, but also for the incremental sales increases of other goods generated by the additional foot traffic from lottery ticket purchasers in the retail outlets.

It is, therefore, an object of the present invention to provide a method and system that allows lottery ticket retailers to market their products and services directly to visitors of lottery websites and associated websites.

It is another object of the present invention to provide a method and system that helps the lottery to build goodwill and a stronger relationship with its lottery retailers.

It is still another object of the present invention to help lotteries reduce retailer opposition to Internet lottery ticket sales by providing lottery ticket retailers with an Internet-based method and system that also can boost the lottery retailers' sales of their own products.

It is still another object of the present invention to help lotteries to increase their ticket sales, especially when jackpots are low, since there will now be new reasons for lottery players to patronize lottery retailers.

It is yet another object of the present invention to build goodwill and a stronger relationship between the lottery and its players and visitors to the lottery's website, who receive special discounts at their local retail stores.

Additional objects and advantages of the invention will be set forth in the description that follows, and in part will be apparent from the description, or may be learned by practice of the invention. The objects and advantages of the invention may be realized and obtained by means of the methods and apparatus pointed out in the appended claims.

### SUMMARY

To achieve the foregoing objects, and in accordance with the purposes of the invention as embodied and broadly described in this document, I have invented a system and method for providing direct marketing opportunities to lottery ticket retailers. According to a preferred method of the present invention, geographic location information for a visitor to a lottery website is received. Address information for one or more lottery ticket retailers is stored in a computer database. The lottery ticket retailer address information and the visitor location information are used to determine one or more local lottery ticket retailers located within a selected distance of the visitor's geographic location or to determine a selected number of local lottery ticket retailers located closest to the visitor's geographic location. Retailer name and address information for the one or more local lottery ticket retailers is then sent to the lottery website visitor. The location of the local lottery ticket retailers can be provided on a map display. The website visitor's selection of a lottery ticket retailer chosen from the list of local lottery ticket retailers is received and advertising for the selected lottery ticket retailer is sent to the lottery website visitor. The advertising can include a promotion for a non-lottery product offered by the selected lottery ticket retailer. The promotion can include, for example, a coupon for a non-lottery product or a special offer by the selected lottery ticket retailer for a non-lottery product.

A preferred system according to the invention includes a host computer system that is programmed to maintain a website including a webpage for each of a plurality of lottery ticket retailers. The computer system can receive a lottery website visitor's selection of one of the plurality of lottery ticket retailers, and in response to the lottery website visitor's selection, can serve the webpage of the selected lottery ticket retailer. The webpage of the selected lottery retailer can include a coupon for a non-lottery product offered by the selected lottery ticket retailer. The webpage of the selected lottery retailer can include a special offer for a non-lottery product offered by the selected lottery ticket retailer.

In one advantageous embodiment, the computer system is programmed to provide the plurality of lottery ticket retailers with access to a webpage template for creating a lottery ticket retailer webpage, which template can include a coupon section and a special offer section. A coupon input form is provided for receiving information for the coupon section. A special offer input form for receiving information for the special offer section.

The method and system of the present invention provides numerous benefits. Among others, it provides lotteries a new marketing support program for their retailers and provides lottery retailers with direct marketing opportunities to lottery players and lottery website visitors. It also creates synergy and goodwill among the lottery, its retailers, and its players. Moreover, it creates additional revenue for the lottery and its retailers, and additional benefits for the players.

### BRIEF DESCRIPTION OF THE DRAWINGS

The accompanying drawings, which are incorporated in and constitute a part of the specification, illustrate the presently preferred methods and embodiments of the invention and, together with the general description given above and the detailed description of the preferred methods and embodiments given below, serve to explain the principles of the invention.

FIG. 1 is a functional block diagram of a preferred host computer system and a network for practicing the present invention.

FIG. 2 is a diagram depicting a preferred method for providing direct marketing opportunities to lottery ticket retailers according to the present invention.

FIG. 3 shows a display of an exemplary retailer web page according to the invention.

FIG. 4 shows an example of a coupon input form for use by a lottery ticket retailer to enter information to be incorporated into the coupon to be displayed on the retailer's webpage.

FIG. 5 shows an example of a text control screen that can be used by an operator of the host computer system to control the text entered into a coupon input form for use by a lottery ticket retailer.

FIG. 6 shows an exemplary screen display of a lottery retailer location screen showing a list of retailers within a selected distance from a lottery website visitor's address.

### DESCRIPTION

In the following description, methods and embodiments of the invention have been shown and described simply by way of illustration of the best mode contemplated by the inventor of carrying out the invention. As will be realized, the invention is capable of modification in various respects, all without departing from the invention. Accordingly, the drawings and description are to be regarded as illustrative in nature, and not restrictive.

In the general Internet marketplace, a manufacturer or service provider utilizes its website to reach potential customers and sell its products by directly selling to such customers and/or by referring those customers to retailers who will sell the provider's products or services. In contrast, according to one important aspect of the present invention the provider of the service or product (i.e., the lottery) utilizes its website to allow an independent retailer of the product to advertise the retailer's place of business and the retailer's other products instead of the services or products of the manufacturer or provider, i.e., non-lottery products. It will be understood that, in the discussion that follows, the term “product” includes a service as well as a product.

According to another important aspect of the invention, it is applied to retailers having a unique relationship with the provider of the service or produce. Lottery ticket retailers fulfill an agency relationship with the lottery i.e., a relationship where the seller (Agent) represents the manufacturer or provider (Principal) and where the agent doesn't take ownership of and resell the products being sold, and is compensated by commission only. In most retailer relationships, the retailer simply buys product from a manufacturer or provider to be resold for profit at a higher price by the retailer. In that setting, there is no agency relationship, as that term is used in this specification. In addition, in the private sector, Agency relationships are strictly contractual. In the lottery industry, however, the Lottery licenses agents (i.e., retailers) pursuant to state law, and it is this state law, not a contract, which prescribes what an agent may and may not do.

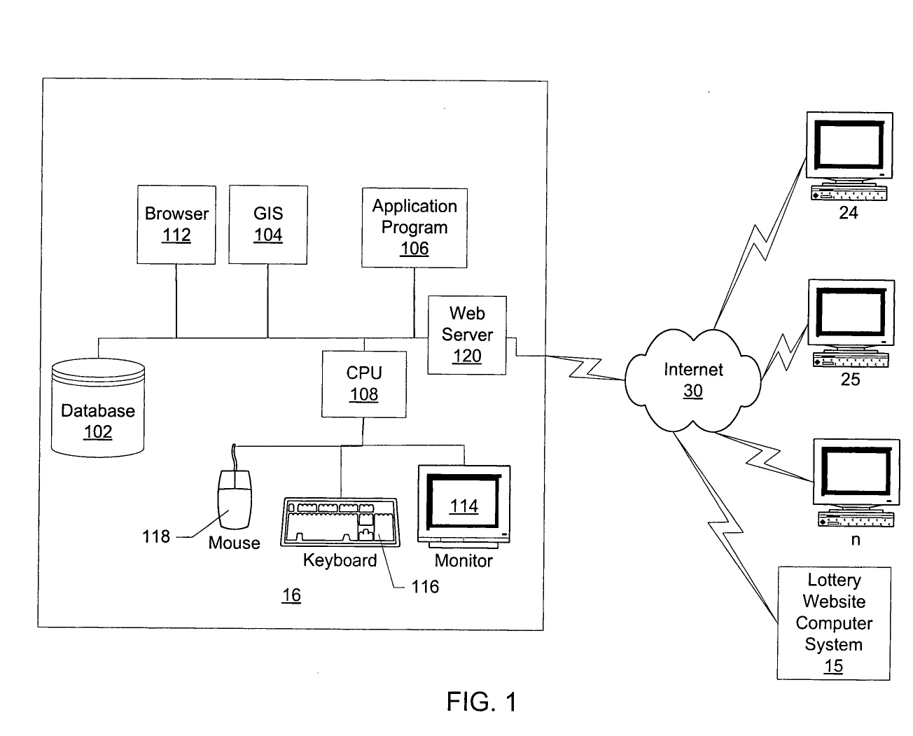

FIG. 1 illustrates a preferred computer network system for practicing the present invention. The system includes a lottery website computer system 15 and a host computer system 16. The host computer system 16 includes a central processing unit (CPU) 108 for processing data and program instructions. The host computer system 16 also includes input and output devices, as is well known in the art. For example, the host computer system 16 preferably includes a display screen or monitor 114, a keyboard 1 16, a mouse 118, a printer (not shown), etc. The host computer system 16 further includes data storage and memory devices, as are known in the art, for storing a database 102, and also includes a geographic information system (GIS) 104, an application program 106, a browser 112 and a web server 120.

The database 102 comprises one or more databases for storing data used by the application program 106, including player location information, lottery ticket retailer address information and data used for generating, saving and displaying retailer web pages, as described below. The database 102 is a relational database, as are well known in the art. In a preferred embodiment, the database is implemented as a Structured Query Language (SQL) server database.

The GIS 104 includes a geocoding engine for assigning geographic coordinates (e.g. latitude-longitude) to street addresses, as well as other points and features. With the geographic coordinates, the GIS 104 can then create a map that includes those features. The GIS 104 cooperates with the database 102 to store and access geographic coordinates for the location of a player (e.g., the player's address) as well as geographic coordinates for the locations of lottery ticket retailers who are registered in the system. One suitable GIS is the RouteMap IMS program marketed by ESRI of Redlands, Calif. Upon reading this specification, those skilled in the art will understand that other GIS programs may also suffice, such as the MapPoint Mapping program marketed by Microsoft Corporation of Redmond, Wash., and the Site Advantage program marketed by MapQuest, Inc. of Denver, Colo. and Mountville, Pa.

The application program 106 is operable with the database 102, the GIS 104 and the web server 120 to provide the functionality described below.

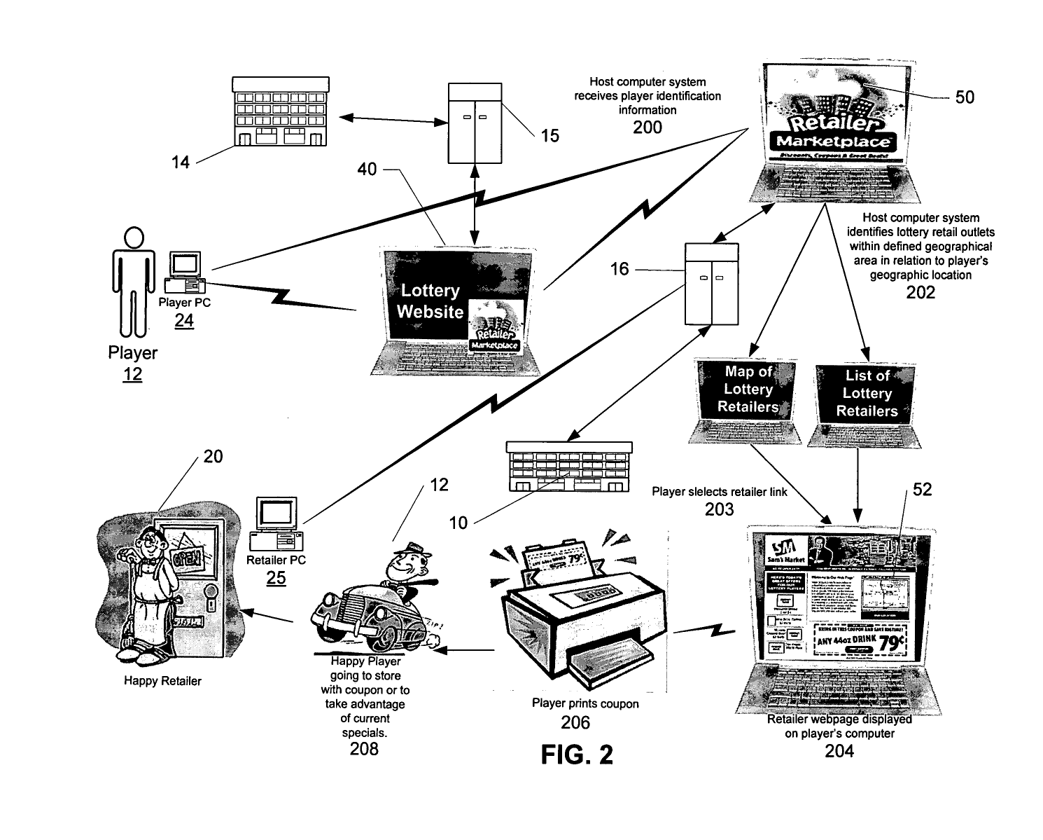

Still referring to FIG. 1, the host computer system 16 is connected to a network 30, which serves as a communications medium with user computers 24, 25 and n (where n refers to any number of users). In a preferred embodiment of the invention, the network 30 comprises the Internet, the host computer 16 comprises a host website 50 (see FIG. 2) and the web server 120 functions to serve web pages to user computers 24, 25 and n. The Internet is a global network of computers. One popular part of the Internet is the World Wide Web, or the “Web.” The World Wide Web includes computers that display graphical and textual information. Computers that provide information on the World Wide Web are typically called “web sites.” A website is defined by an Internet address that has an associated electronic page, often called a “home page.” Generally, a home page is an electronic document that organizes the presentation of text, graphical images, audio and video into a desired display. Upon reading this specification, those skilled in the art will understand that, under appropriate circumstances, considering issues such as developments in computer hardware, software and connectivity, etc., other network configurations and devices also may suffice, such as for example, PDAs connected via a wireless network, etc.

Referring to FIG. 2, the host computer system 16 interacts with a lottery player 12 seeking to participate in lottery play, with a lottery operator 14 and with a lottery ticket retailer 20. The lottery player 12 can include any person who visits a lottery website 40 or associated websites, whether or not they are currently playing the lottery. The lottery can be a State Lottery or a Jurisdictional Lottery found outside the United States. The lottery operator 14 can be a governmental entity, such as a state lottery, or a representative of a state. One example of a lottery operator that is a representative of a state is the Georgia Lottery Corporation, which is referred to as a quasi-state agency and which runs the lottery for the state of Georgia. The lottery operator 14 also can include a third-party provider, such as an online provider that operates the on-line lottery games for a state or other governmental entity. The host computer system 16 is operated by a host website operator 10. The host website operator 10 can be the lottery operator 14 or it can be a third party other than the lottery operator 14, as depicted in FIG. 2.

Still referring to FIG. 2, the host website 50 includes lottery retailer registration functionality for providing for the registration and login of lottery retailers 20 who use the system. The host website 50 can store a lottery retailer webpage 52 for each registered lottery retailer. Each registered lottery retailer can create and store their webpage 52 on the host computer system 16. According to a preferred method, a lottery retailer 20 can store their webpage 52 by uploading a pre-designed lottery retailer webpage, or the lottery retailer 20 can complete their lottery retailer webpage 52 using pre-designed templates available on the host website 50, as described in more detail below. Upon reading this specification, those skilled in the art will understand that the lottery retailer webpage 52 also can be stored on a website other than the host website 50. For example, the retailer webpage can be stored on the retailer's own website.

In a presently preferred embodiment, the host website 50 is implemented using the ASP.NET technology for creating dynamic Web applications. The ASP.NET technology is part of the .NET framework, which is developed and marketed by Microsoft Corporation of Redmond, Wash. The .NET framework is a development and execution environment that allows different programming languages and libraries to work together to create Windows and Web-based applications that are relatively easy to build, manage, deploy, and integrate with other networked systems. ASP.NET provides a programming model, and infrastructure, to create scalable, secure and stable applications relatively quickly and easily. ASP.NET pages (i.e., web forms) are compiled, providing better performance than with scripting languages.

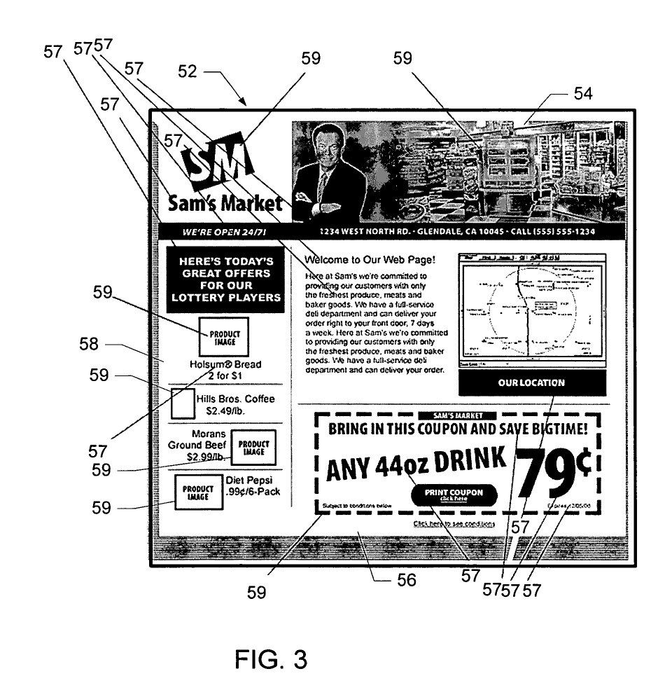

FIG. 3 shows a display of a preferred form of retailer webpage 52 according to the invention. The retailer webpage 52 provides information about the selected retailer. This information can include, for example, the retailers' address, telephone number, store hours, general information, a map showing the retailer's location, and promotions for the retailer's own products or services to website visitors to the retail store to take advantage of the store's offerings. In one preferred embodiment, the webpage 52 includes a masthead 54, a coupon section 56 and a special offer section 58, as well as other information about the retailer. According to one beneficial aspect of the invention, the lottery retailer 20 can design and store the webpage 52 using tools available to the lottery retailer on the host website 50. In one preferred embodiment, these tools include pre-designed templates stored in the database 102 from which the lottery retailer 20 can select to choose the general layout of the retailer's webpage 52. Using the pre-designed webpage templates, the lottery retailer 20 need only choose the template design and enter text elements 57 where required by the template to create the general layout of the webpage 52.

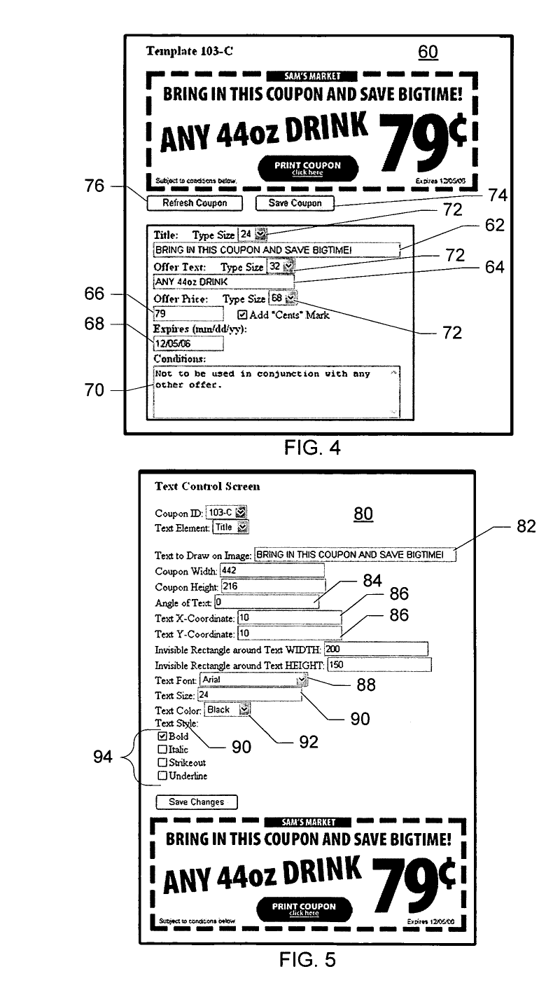

The host website tools also include input forms that the lottery retailer 20 can use to create and store the masthead 54, coupon section 56 and special offer section 58 to be used in the webpage 52. FIG. 4 shows an example of a coupon input form 60 by which a lottery retailer can enter information to be incorporated into the coupon to be displayed on the retailer's webpage 52. The coupon input form 60 includes input fields that the retailer can use to provide specific information about a coupon, including a Title field 62, an Offer Text field 64, an Offer Price field 66, an expiration date field 68 and a Conditions field 70. The coupon input form 60 also includes Type Size inputs 72, which allow the lottery retailer 20 to adjust the type size used in the coupon, or a combination thereof. The advantage of using a coupon input form, such as shown in FIG. 4, is that it allows retailers to easily create and store coupons for their webpage, simply by entering the basic information shown in FIG. 4. The system then uses this information to create the coupon in the webpage. A similar input form is also provided to the lottery ticket retailer for inputting text for the special offers and masthead sections. In this way, text elements 59 of the retailer webpage 52 can easily be changed by the lottery ticket retailer 20.

As previously discussed, a presently preferred embodiment of the host website is implemented using the ASP.NET technology. Advantageously, ASP.NET provides integration with the standard HTML file upload control which allows the upload of an image/file to be handled on the server side. This HTML file upload control allows a user to browse and select image files and allows the web server 120 to upload the image files to be stored for the retailer's use in the retailer's webpage 52, including in the masthead 54, coupon section 56 and special offer section 58 of the webpage 52. Once the images are uploaded, the retailer 20 can use the Windows Graphics Programming Interface (GDI) available in this preferred embodiment of the host website 50 to resize and manipulate the images for creating the retailer webpages 52, including images 59 for the masthead 54, the coupon section 56 and the special offer section 58, as shown in FIG. 3. In a preferred embodiment, Microsoft Windows GDI+ subsystem (which is the subsystem of the Windows XP operating system or Windows Server 2003 that is responsible for displaying information on screens and printers) is used to manipulate images. GDI+ subsystem provides two-dimensional vector graphics, imaging, and typography and allows any string of text or image to be drawn, or painted, on an image. The .NET framework provides a rich library of classes that can interact with the GDI+ subsystem to resize and manipulate the uploaded images and drawing text onto images.

Referring again to FIG. 4, once the retailer 20 completes the coupon input form 60, the retailer can save the coupon form by selecting the “Save Coupon” button 74, which stores the information to the database 102. The “Refresh Coupon” button 76 allows the retailer to preview how the coupon will appear on the retailer's webpage, after entering or editing the text. Generally, the retailer will perform this preview before saving coupon text information to the database 102. Preferably, input forms similar to the coupon input form 60 also are provided for creating and storing the masthead 54 and the special offers section 58 of the retailer webpage 52. Using the selected webpage template and the information from the input forms, the system can create the retailer's webpage 52. According to a preferred embodiment, ASP.NET User Controls can be used to generate the layout of the retailer's webpage and to display the masthead coupons, special offers and masthead. ASP.NET User Controls encapsulate a block of HTML that can be dynamically loaded and inserted into any parent ASP.NET web form. ASP.NET User Controls also can optionally contain their own HTML controls (textbox, drop-down list, buttons, etc.) and code or script to execute user requests or commands. After the retailer's information for its webpage 52 is stored, and before the webpage 52 is allowed to go “live,” the webpage is reviewed and approved by the host website operator to assure that the webpage complies with any applicable requirements or instructions from the lottery, such as restrictions that the lottery may have for webpage content. The retailer can also send images or instructions to the host website 10 operator so that the host website operator can create the webpage 52 for the retailer.

FIG. 5 shows an example of text control screen display 80 used by the host website operator for creating a coupon input form 60, according to a preferred embodiment. The text control screen 80 allows the host website operator to control the appearance and location of all text that is entered into a coupon template by the retailer 20. The text control screen 80 includes settings for every text element for every template. For example, the text control screen display of FIG. 5 shows settings for the Title text element of the coupon 60, including input fields for text 82, text angle 84, text coordinates 86, text font 88, text size 90, text color 92 and text style 94.

Referring again to FIG. 2, a preferred a method for providing direct marketing opportunities to lottery ticket retailers using the system of FIG. 1 will now be described. The lottery website visitor 12 can communicate with the lottery website computer 15 and the host computer system 16 via the user computer 24 and the network (not shown). The lottery ticket retailer 20 also can communicate with the host computer system 16 via the user computer 25 and the network (not shown). The host computer system 16 receives identification information sufficient to determine the lottery website visitor's address (step 200). Suitable identification information can include, for example, the visitor's address, a member number or other identification from which the visitor's address can be determined. This identification information can be provided to the host computer system 16 in any suitable manner. For example, the information can be provided to the host computer system 16 through a club or registry maintained by or on behalf of the lottery, or the visitor 12 may provide their address after selecting a link on the lottery website 40 to the host website 50 or to another website. In a preferred embodiment, the lottery website 40 includes a link to the host website 50. When the lottery website visitor 12 selects this link, the visitor's browser is directed to the host website 50, which prompts the visitor 12 to enter a member ID or to register with the host website 50 if the visitor 12 is not already registered.

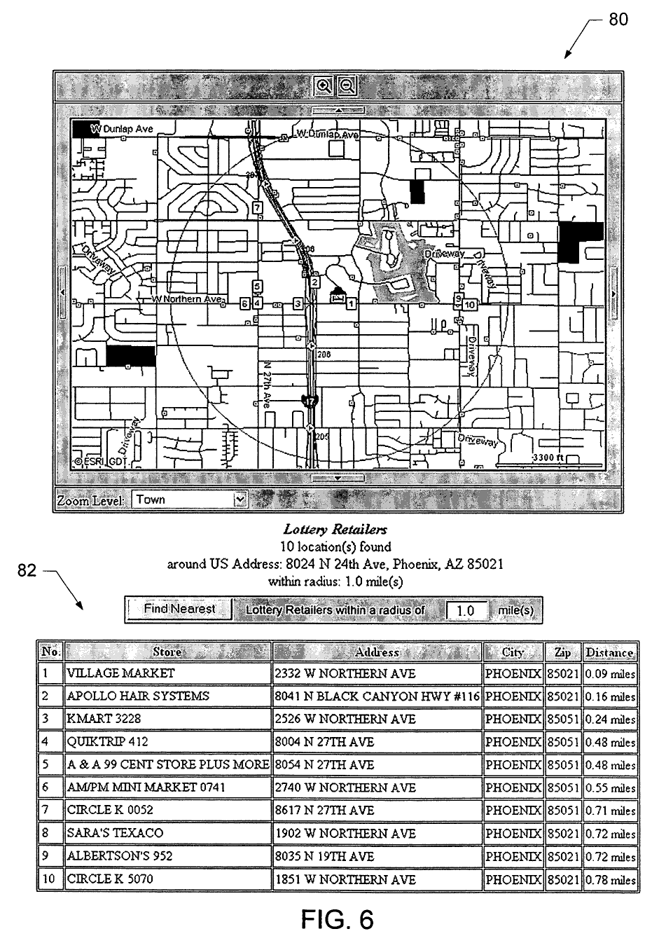

After the host computer system 16 receives the identification information for the lottery website visitor 12, the GIS 104 uses the visitor's geographic location information to identify lottery retail outlets that are located within a defined geographical area in relation to that visitor's geographic location (step 202). In a preferred embodiment, this lottery retailer identification information is provided in the form of a map and/or a list of such lottery retailers. The information can include a certain number of lottery retailers (e.g., the closest twenty lottery retailers to the visitor's address), or it can include all lottery retailers within a certain distance, by zip code or by some other unit of measurement or some combination thereof. Preferably, the list of lottery retailers includes information about the retail store, cross streets, address, telephone number and other information. FIG. 6 shows one example of a screen display 80 of lottery retailer information provided in this manner. The screen display 80 includes a link for each retailer listed. The retailer links can be provided in any suitable form. In the preferred embodiment shown in FIG. 6, the retailer links are displayed in a numbered list 82, which list includes the name and location of each retailer, as well as the distance from the player's location. Also, the screen display 80 includes a map display 84 with each retailer location represented on the map by a number corresponding to the number of that retailer in the numbered list 82. For example, in the screen display of FIG. 6, the first listed retailer is the Village Market. The information listed for the Village Market includes its address and distance from the player's address (i.e., 0.09 miles). The location of the Village Market is shown on the map 84 by the number 1, which corresponds to the number 1 assigned to the Village Market in the list 82.

When the visitor 12 selects a retailer link on the screen display 80 (step 203), the retailer webpage 52 for the selected retailer is then displayed on the visitor's computer 24 (step 204). As shown in FIG. 3, one preferred webpage includes retailer announcements, and promotions, such as special offers, coupons with printing capability, etc. Using the displayed webpage 52, the visitor 12 then take advantage of these retailer promotions. For example, the visitor 12 can print a displayed coupon 60 (step 206) and can use the printed coupon by physically visiting the retailer's store location (step 208).

Upon reading this specification, those skilled in the art will understand that, under appropriate circumstances, considering issues such as user preference, services offered by the host website operator, market demand, subject area, etc., other functions may be included and can be used to provide other benefits to the lotteries, their ticket retailers and their players, as well. For example, the host computer system can also receive the player's email address, along with their geographic location. This email address can be used to send out promotional emails for the lottery or to send out promotions for the lottery retailers to players within a certain vicinity of their store. The retailers may also promote the host website 50 through advertising in the retailer stores.

From the foregoing, it can be seen that the present invention provides a number of advantages over the previously known art. Through the host website, which has a link from the lottery's website, the lottery website visitors can be provided with special announcements or advertisements directly from lottery retail outlets for non-lottery products with coupon printing capability. This in turn can drive those same visitors to the retail stores to take advantage of the non-lottery special offers or other promotions. This process allows the retail stores to reach not only those visitors they thought represented lost traffic, but others who have not purchased lottery tickets through their store or who, for one reason or another, do not buy their lottery tickets through retailers. Such a process gives the lottery retailers an opportunity to increase their overall retail sales, thus eliminating the objection to the lottery pursuing other means of selling tickets. By helping the retailers to attract lottery website visitors to their stores, the lottery also will benefit from more lottery ticket sales because when players return to the retailers they are likely to buy more lottery tickets, especially instant tickets and other ‘impulse’ lottery offerings.

The invention in its broader aspects is not limited to the specific details, representative devices, and illustrative examples shown and described. Those skilled in the art will appreciate that numerous changes and modifications may be made to the preferred embodiments of the invention and that such changes and modifications may be made without departing from the spirit of the invention.

What is claimed is:

1. A method for providing direct marketing opportunities to lottery ticket retailers, the method comprising:
receiving geographic location information for a visitor to a lottery website;
storing in a computer database address information for one or more lottery ticket retailers; and
using the lottery ticket retailer address information and the visitor location information to determine:
one or more local lottery ticket retailers located within a selected distance of the visitor's geographic location; or
a selected number of local lottery ticket retailers located closest to the visitor's geographic location.

2. The method of claim 1 further comprising sending address information for the one or more local lottery ticket retailers to the lottery website visitor.

3. The method of claim 2 further comprising receiving a selection of a selected lottery ticket retailer from the local lottery ticket retailers and sending to the lottery website visitor advertising for the selected lottery ticket retailer.

4. The method of claim 3 wherein the advertising includes a promotion for a non-lottery product offered by the selected lottery ticket retailer.

5. The method of claim 4 wherein the promotion includes a coupon for a non-lottery product offered by the selected lottery ticket retailer.

6. The method of claim 4 wherein the promotion includes a special offer for a non-lottery product offered by the selected lottery ticket retailer.

7. The method of claim 2 wherein the address information for the one or more local lottery ticket retailers is provided on a map display.

8. A system for providing for providing direct marketing opportunities to lottery ticket retailers, the system comprising:
a computer system programmed to:
receive geographic location information for a visitor to a lottery website;
store in a computer database address information for one or more lottery ticket retailers; and
use the lottery ticket retailer address information and the visitor location information to determine:
one or more local lottery ticket retailers having an address within a selected distance of the visitor's geographic location; or
a selected number of local lottery ticket retailers located closest to the visitor's geographic location.

9. The system of claim 8 wherein the computer system is programmed to send address information for the one or more local lottery ticket retailers to the lottery website visitor.

10. The system of claim 8 wherein the computer system is programmed to receive a selection of a selected lottery ticket retailer from the local lottery ticket retailers and to send to the lottery website visitor non-lottery advertising for the selected lottery ticket retailer.

11. The system of claim 10 wherein the advertising includes a promotion for a non-lottery product offered by the selected lottery ticket retailer.

12. The method of claim 11 wherein the promotion includes a coupon for a non-lottery product offered by the selected lottery ticket retailer.

13. The method of claim 11 wherein the promotion includes a special offer for a non-lottery product offered by the selected lottery ticket retailer.

14. The system of claim 9 wherein the address information for the one or more local lottery ticket retailers is provided on a map display.

15. A method for providing direct marketing opportunities to lottery ticket retailers, the method comprising:
maintaining a website including a webpage for each of a plurality of lottery ticket retailers;
receiving a lottery website visitor's selection of one of the plurality of lottery ticket retailers; and
serving to the lottery website visitor the webpage of the selected lottery ticket retailer.

16. The method of claim 15 wherein the webpage of the selected lottery ticket retailer includes a coupon for a non-lottery product offered by the selected lottery ticket retailer.

17. The method of claim 15 wherein the webpage of the selected lottery ticket retailer includes a special offer for a non-lottery product offered by the selected lottery ticket retailer.

18. The method of claim 15 further comprising a step of providing the plurality of lottery ticket retailers with access to a webpage template for creating a lottery ticket retailer webpage.

19. The method of claim 18 wherein the webpage template includes a coupon section.

20. The method of claim 19 further comprising a step of providing a coupon input form for receiving information for the coupon section.

21. The method of claim 18 wherein the webpage template includes a special offer section.

22. The method of claim 21 further comprising providing a special offer input form for receiving information for the special offer section.

23. A system for providing direct marketing opportunities to lottery ticket retailers, the system comprising:
a computer system programmed to:
maintain a website including a webpage for each of a plurality of lottery ticket retailers;
receive a lottery website visitor's selection of one of the plurality of lottery ticket retailers; and
in response to the lottery website visitor's selection, serve the webpage of the selected lottery ticket retailer.

24. The system of claim 23 wherein the webpage of the selected lottery retailer includes a coupon for a non-lottery product offered by the selected lottery ticket retailer.

25. The system of claim 23 wherein the webpage of the selected lottery retailer includes a special offer for a non-lottery product offered by the selected lottery ticket retailer.

26. The system of claim 23 wherein the computer system is programmed to provide the plurality of lottery ticket retailers with access to a webpage template for creating a lottery ticket retailer webpage.

27. The system of claim 26 wherein the webpage template includes a coupon section.

28. The system of claim 27 wherein the computer system is programmed to provide a coupon input form for receiving information for the coupon section.

29. The system of claim 26 wherein the webpage template includes a special offer section.

30. The system of claim 29 wherein the computer system is programmed to provide a special offer input form for receiving information for the special offer section.

31. A method for providing direct marketing opportunities to lottery ticket retailers, the method comprising:
maintaining a lottery website;
receiving and storing geographic location information for a visitor to the lottery website;
receiving and storing address information for one or more lottery ticket retailers; and
using the lottery ticket retailer address information and the visitor location information to determine:
one or more local lottery ticket retailers having an address within a selected distance of the visitor's geographic location; or
a selected number of local lottery ticket retailers located closest to the visitor's geographic location.

32. The method of claim 31 further comprising sending address information for the one or more local lottery ticket retailers to the lottery website visitor.

33. The method of claim 32 further comprising:
receiving the lottery website visitor's selection of a selected lottery ticket retailer from the one or more local lottery ticket retailers; and
in response to the selection, sending to the lottery website visitor non-lottery advertising information for the selected lottery ticket retailer.

34. The method of claim 31 further comprising maintaining a website including a webpage for the one or more lottery ticket retailers.

35. The method of claim 34 further comprising:
receiving the lottery website visitor's selection of a selected lottery ticket retailer from the one or more local lottery ticket retailers; and
in response to the selection, serving the webpage of the selected lottery ticket retailer.
